(19) United States
(12) Patent Application Publication
(10) Pub. No.: US 2010/0020533 A1
(43) Pub. Date: Jan. 28, 2010

(54) LIGHT SOURCE UNIT AND DISPLAY DEVICE

(75) Inventor: Kentaro Kamada, Kameyama-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/442,112

(22) PCT Filed: Sep. 5, 2007
(86) PCT No.: PCT/JP2007/067313

§ 371 Date: Mar. 20, 2009

(30) Foreign Application Priority Data
Dec. 6, 2006 (JP) 2006-329852

(51) Int. Cl. G02F 1/13357; F21V 3/00

(52) U.S. Cl. 362/97.1; 362/311.01

(57) ABSTRACT

A light source unit prevents deterioration of display qualities, caused by “sagging” of a diffuser and includes a light source, a diffuser, and a light source chassis, the light source and the diffuser being arranged in this order from the bottom within the light source chassis. A mounting base is arranged below a corner of the diffuser, a holding member is arranged above the corner of the diffuser, the mounting base and the holding member are coupled with each other, and the diffuser is interposed between the mounting base and the holding member. The holding member preferably has a light-shielding property and the mounting base and the holding member are coupled with each other, with a screw, for example.

### BACKGROUND OF THE INVENTION

1. Field of the Invention

The present invention relates to a light source unit and a display device. More particularly, the present invention relates to a light source unit that is suitable for use as a direct type backlight in a liquid crystal display device, and a display device.

2. Description of the Related Art

The light source unit is used, for example, in a display device including a non-self-emission display panel. In a liquid crystal display device, for example, a liquid crystal panel itself does not emit light. Therefore, a transmissive or semi-transmissive liquid crystal display device is provided with a backlight which causes light to enter a liquid crystal panel.

There are currently two different backlights used in a liquid crystal display device and the like: an edge light type (side light type) and a direct type. The direct type backlight has advantages in that it is suitably used in a large-sized display device and easily provides a high luminance. The liquid crystal display device currently has become dramatically larger because a process of using a larger mother glass has been completed, for example. Now the liquid crystal display device has established a position as a household television. In a television, brightness is an important basic performance characteristic. Therefore, a liquid crystal display device equipped with a large screen needs to include a large backlight which provides a high luminance, and therefore, such a liquid crystal display device has been increasingly provided with a direct type backlight.

According to structural characteristics of the direct type backlight, a plurality of light sources such as a cold cathode fluorescent lamp are provided on a back surface of a display panel such as a liquid crystal panel, and as a result, the direct type backlight has the following advantages. Many light sources can be arranged, thereby increasing a light amount; loss of light is small because light is caused to enter the display panel from the light sources without change in optical path; and the size of the display device can be easily increased. Further, in the direct type backlight, a diffuser or an optical sheet is generally arranged between the display panel and the light source in order to make uniform optical characteristics such as in-plane luminance.

The diffuser tends to sag or deform due to influences such as a difference in temperature between the light source side and the display panel side. The difference in temperature is generated by heat from the light source. Particularly in a large-sized display panel, the diffuser is also large, and therefore, the “sagging” of the diffuser is markedly caused. If the diffuser sags, light, which originally passes through an edge of the diffuser and enters the display panel, enters the display panel without passing through the diffuser. Therefore, uniformity of optical characteristics such as in-plane luminance is deteriorated.

In an attempt to solve this problem, Japanese Kokai Publication No. 2004-186080 and Japanese Kokai Publication No. 2004-327449 disclose that a supporting member which projects from the bottom surface side of a backlight is arranged in order to prevent the “sagging” and the like of a diffuser. Japanese Kokai Publication No. 2004-192912 discloses that a diffuser and a frame are integrally arranged. Japanese Kokai Publication No. 2003-249101 discloses that a diffuser is provided with a reinforcing element and further, a screw is fixed to the reinforcing element, thereby preventing the diffuser from warping. Japanese Kokai Publication No. Hei-06-230383 discloses a method of fixing a diffuser or a polarizer at plural positions by a fixing member. Further, Japanese Kokai Publication No. 2005-49896 discloses a method of preventing the “sagging” of a diffuser by forming a through-hole in a lamp (light source) chamber and thereby opening the hermetic state of the lamp chamber. However, for example, in a liquid crystal display device for TV, which is getting larger, prevention of the deterioration of display qualities, caused by the “sagging” of the diffuser, is particularly strongly needed. In order to prevent the deterioration of display qualities more easily and effectively, the inventions described above still have room for improvement.

### SUMMARY OF THE INVENTION

In view of the above-mentioned state of the art, preferred embodiments of the present invention provide a light source unit and a display device, each capable of preventing deterioration of display qualities, caused by the “sagging” of the diffuser.

The present inventor made various investigations on a liquid crystal display device for TVs, which is getting larger. The inventor discovered that at a corner of a display region, display qualities are markedly deteriorated. As such deterioration of display qualities, a phenomenon in which a white portion is observed at four corners of the display region at the time of black state was observed. Then, the inventor discovered the following. Particularly in the case that a large-sized display panel is used, the “sagging” of the diffuser is markedly generated at corners of the display region, which causes light leakage at the corners of the diffuser. Therefore, the display qualities are deteriorated. Further, the inventor discovered that this deterioration of display qualities can be effectively prevented as follows. A holding member for holding down the diffuser on a diffuser-mounting base arranged within a light source chassis is arranged, thereby interposing a corner of the diffuser between the mounting base and the holding member. As a result of this unique arrangement and structure, the diffuser is prevented from warping and thereby, light leakage generated at the corner of the diffuser is sufficiently suppressed and minimized. As a result, the above-mentioned problems have been admirably solved, leading to development and completion of preferred embodiments of the present invention.

According to a preferred embodiment of the present invention, a light source unit includes a light source, a diffuser, and a light source chassis, the light source and the diffuser being arranged in this order from a bottom within the light source chassis, wherein a mounting base is arranged below a corner of the diffuser, a holding member is arranged above the corner of the diffuser, the mounting base and the holding member are coupled with each other, and the diffuser is interposed between the mounting base and the holding member.

According to a light source unit of a preferred embodiment of the present invention, the light sources and the diffuser are arranged in this order from the bottom within the light source chassis, i.e., in this order from the bottom of the light source chassis. The light source chassis is not especially limited as long as it is a case within which the light sources are placed. The light sources are not especially limited, and examples thereof include a dot light source and a linear light source. A light-emitting diode (LED) is mentioned as the dot light source, for example. A cold cathode fluorescent lamp and a hot cathode fluorescent lamp are mentioned as the linear light source, for example. Further, the shape, material, size, and the like of the diffuser are not especially limited as long as it has a function of diffusing light incident from the light sources.

The mounting base is arranged below corners of the diffuser and the holding member is arranged above the corners of the diffuser. The mounting base is a structure on which the diffuser is mounted. The mounting base is generally arranged along an inner wall surface of the light source chassis constituting an exterior frame of the light source unit so as not to interrupt light from the light sources. If such a mounting base is arranged separately from the light source chassis, the light source unit can be provided with various functions more efficiently in comparison to the case that the light source chassis is processed. As a result, a lamp assembly efficiency is improved. The shape, size, material, and the like of the holding member are not especially limited as long as it is mounted on the diffuser and it covers the corner of the diffuser. It is preferable that the holding member has an inflexibility that is greater than that of the diffuser. As mentioned below, the “sagging” of the diffuser is most markedly observed at corners of the diffuser. Therefore, the mounting base is arranged at least below the corners of the diffuser, and the holding member is arranged at least above the corners of the diffuser. Such mounting base and holding member are arranged to interpose the diffuser therebetween. In this preferred embodiment, the mounting base and the holding member are not necessarily close to the diffuser, but preferably as close to the diffuser as possible. If a surface in contact with the diffuser, of the mounting base, is further provided with fine irregularities, noise generated when the diffuser contacts the mounting base, for example, by vibration, can be prevented.

FIG. 9 is a planar perspective view of a commonly used light source unit. FIG. 10 is a cross-sectional schematic view of the light source unit taken along dashed line X-Y in FIG. 9. As shown in FIG. 10, the light source unit generally has a structure in which light sources 1, a diffuser 7, and a display panel 14 are stacked in this order from the bottom, within a frame 12. If such a light source unit is used for a certain period, “sagging” of the diffuser 7 is generated due to heat from the light sources 1, as shown in FIG. 10. This “sagging” causes light leakage at corners of the diffuser 7, resulting in deterioration of display qualities. The mounting base and the holding member according to various preferred embodiments of the present invention are arranged in order to prevent such “sagging” of the diffuser. The mounting base and the holding member need to cover at least corners of the diffuser where the “sagging” of the diffuser is most markedly observed. For example, if the diffuser 7 has a rectangular main surface, as shown in FIG. 9, the mounting base and the holding member hold the diffuser 7, which is interposed therebetween, at the four corners 13a, 13b, 13c, and 13d. According to the light source unit of preferred embodiments of the present invention, the mounting base and the holding member cover the corners of the diffuser. Therefore, the diffuser can be prevented from sagging, and generation of light leakage can be prevented at the corners of the display region. As a result, the deterioration of display qualities can be prevented.

The mounting base and the holding member are coupled with each other, and the diffuser is interposed between the mounting base and the holding member. Thus, the diffuser is fixed by being interposed between the mounting base and the holding member, and thereby the “sagging” of the diffuser can be prevented. In the present invention, the coupling method is not especially limited as long as the mounting base is coupled with and fixed to the holding member. The mounting base and the holding member may not be close to each other. The mounting base is coupled with the holding member, with a screw, a double-sided tape, or other suitable fixing or connecting member or material, or they may engaged with each other, for example. Among these, it is preferable that the mounting base and the holding member are coupled with each other, with a screw, for example. If a screw is used for coupling them with each other, the mounting base and the holding member can be easily fixed, and the height of the holding member can be easily adjusted. According to the present preferred embodiment, the screw does not penetrate the diffuser, and therefore, problems such as breakage of the diffuser are not generated. Further, it is generally difficult to provide the diffuser with a threaded hole, due to the diffuser's structure. Therefore, productivity can be improved.

The configuration of the light source unit of the present invention is not especially limited as long as the above-mentioned light source, diffuser, mounting base, and holding member are included. The light source unit may or may not include other components.

The diffuser more sags on the short sides than on the long sides. Therefore, the mounting base and the holding member are preferably arranged on the short sides of the diffuser. It is more preferable that the mounting base and the holding member are arranged on both of the short and long sides. That is, it is preferable that the mounting base and the holding member are circularly arranged along an outer edge of the diffuser. According to such a preferred embodiment, the mounting base and the holding member are arranged along the entire outer edge of the diffuser. Therefore, the light leakage caused by the “sagging” of the diffuser can be more surely suppressed and minimized. As a result, the deterioration of display qualities can be effectively prevented. Thus, the holding member is arranged on each side of the diffuser, and each side of the diffuser is pressed. According to this preferred embodiment, the sagging of the diffuser can be more effectively prevented in comparison to the case that the diffuser is pressed at points. Further, damages which might be caused by vibration and the like can be minimized and prevented.

It is preferable that the mounting base is made of polycarbonate or polypropylene, for example. It is preferable that the mounting base included in the light source unit of a preferred embodiment of the present invention has reflectivity. In such a preferred embodiment, light use efficiency can be improved. Polycarbonate and polypropylene are preferably used as a material for the mounting base because polycarbonate and polypropylene can become white if they are each mixed with a reflective material. The reflectance can be arbitrarily changed in accordance with a concentration of the reflective material. Use of these materials makes it possible to easily perform a processing treatment, e.g., formation of a threaded hole for the above-mentioned screw. Further, the use of such a plastic material leads to a reduction in weight of the mounting base.

It is preferable that the holding member has a light-shielding property. In such a preferred embodiment, light leaked from the diffuser can be more surely shielded even if the diffuser slightly sags. The light-shielding property used herein means that a light-shielding ratio for light (visible light) having a wavelength of about 380 nm to about 780 nm is approximately 80% or more. The following methods may be mentioned as a method of providing the holding member with light-shielding property, for example: a method of using a light-shielding material for the holding member; a method of subjecting a surface of the holding member to light-shielding treatment; and a method of attaching a light-shielding member to the surface of the holding member. As the method of subjecting the holding member surface to a light-shielding treatment, coating of a light-shielding coating material, formation of a metal thin film by deposition and the like, may be mentioned, for example. As the method of attaching a light-shielding member to the holding member surface, attachment of a light-shielding tape, attachment of a light-shielding sheet with a cohesive member, and the like, may be mentioned.

It is preferable that the holding member has reflectivity. In such a preferred embodiment, light use efficiency can be improved. In the present description, the reflectivity means that a reflectance for light (visible light) having a wavelength of about 380 nm to about 780 nm is approximately 80% or more. The following methods may be mentioned as a method of providing the holding member with reflectivity, for example: a method of using a reflective material for the holding member; a method of subjecting a surface of the holding member to a light reflection treatment; and a method of attaching a reflective member to a surface of the holding member. As the method of subjecting the holding member surface to a light reflection treatment, coating of a reflective coating material, formation of a metal thin film by deposition and the like, may be mentioned, for example. As the method of attaching a reflective member to the holding member surface, attachment of a reflective tape, attachment of a reflective sheet with a cohesive member, and the like, may be mentioned.

It is preferable that the holding member is made of polycarbonate or polypropylene, for example. Polycarbonate and polypropylene easily can become white if they are each mixed with a reflective material. Therefore, if such materials are used as a material for the holding member, the reflectance of the holding member can be arbitrarily changed in accordance with a concentration of the reflective material. Further, use of these materials makes it possible to easily perform a processing treatment, e.g., formation of a threaded hole for the above-mentioned screw. Further, the use of such a plastic material leads to a reduction in weight of the holding member. In addition, the holding member made of such a plastic material has inflexibility and therefore does not warp, unlike the diffuser. Therefore, such a holding member has a high holding effect.

It is preferable that the holding member is made of aluminum or iron, for example. If aluminum or iron is used as a material for the holding member, the holding member can be easily provided with light-shielding property and reflectivity. The holding member made of such a metal material has inflexibility and therefore does not warp, unlike the diffuser. Therefore, such a holding member has a high holding effect.

It is preferable that the diffuser is made of polycarbonate or a methyl methacrylate-styrene copolymer, for example. If polycarbonate (PC) or a methyl methacrylate-styrene copolymer (MS) is used for the diffuser, a diffuser excellent in durability, transparency, and lightweight property can be obtained.

It is preferable that the diffuser has a lens structure. Optical sheets such as a diffusion sheet, a lens sheet, and a polarization sheet, for changing characteristics of light which has passed through the diffuser are generally arranged on the diffuser. The diffuser in the present preferred embodiment is prepared by providing a diffuser with lens functions which such an optical sheet and the like has. For example, a preferred embodiment in which a lenticular lens is stacked on a common diffuser and thereby they are integrated with each other is mentioned. In this preferred embodiment, a lens portion of the diffuser can be prevented from irregularly sagging due to heat, and as a result, the diffuser functions and the lens functions can be consolidated and the effect of improving the luminance can be obtained.

Another preferred embodiment of the present invention provides a display device including the light source unit. The display device according to a preferred embodiment of the present invention includes the light source unit where the corners of the diffuser are interposed between the mounting base and the holding member. Therefore, the deterioration of display qualities, caused by the “sagging” of the diffuser, can be effectively prevented. As a result, the display device can exhibit excellent display qualities. A display device including a non-self-emission display panel is mentioned as the above-mentioned display device. For example, a liquid crystal display device including the liquid crystal panel is preferable. That is, the light source unit according to a preferred embodiment of the present invention is preferably used as an illumination device for display devices, and particularly preferably used as a direct type backlight for liquid crystal display devices. It is preferable that the display device constitutes a television receiver, for example. The display device according to a preferred embodiment of the present invention includes the direct type light source unit where the diffuser is arranged above the light sources. Therefore, the display device is suitable for a television receiver which needs to be increased in size.

According to the light source unit of various preferred embodiments of the present invention, the corners of the diffuser are interposed between the mounting base and the holding member. Therefore, the deterioration of display qualities, caused by the “sagging” of the diffuser, can be effectively prevented.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1-1 is a perspective exploded view schematically showing the configuration of the direct type liquid crystal display device in accordance with Preferred Embodiment 1.

FIG. 1-2 is a cross-sectional view schematically showing the configuration of the direct type liquid crystal display device in accordance with Preferred Embodiment 1, as viewed in the direction perpendicular to the longitudinal direction of the linear light source.

FIGS. 2A and 2B are views schematically showing the method of holding linear light sources in the direct type liquid crystal display device in accordance with Preferred Embodiment 1, wherein FIG. 2A is an enlarged perspective view of the light source-holding member, and FIG. 2B is a planar view showing arrangement of the light source-holding member.

FIGS. 3A and 3B are planar views schematically showing the structure of the plastic frame in the backlight in accordance with Preferred Embodiment 1, wherein FIG. 3A shows a plastic frame used in Preferred Embodiment 1, and FIG. 3B shows another plastic frame used in Preferred Embodiment 1.

FIGS. 4A and 4B are perspective views schematically showing an arrangement relationship among the plastic frame, the diffuser, and the holding member in the backlight in accordance with Preferred Embodiment 1, wherein FIG. 4A is an enlarged planar view schematically showing the diffuser and the holding member, and FIG. 4B is an overall view showing the diffuser and the holding member.

FIG. 5 is a perspective view schematically showing an arrangement relationship among the plastic frame, the diffuser, and the holding member in the backlight in accordance with Preferred Embodiment 2.

FIG. 6 is a perspective view schematically showing an arrangement relationship among the plastic frame, the diffuser, and the holding member in the backlight in accordance with Preferred Embodiment 3.

FIG. 7 is a perspective view schematically showing an arrangement relationship among the plastic frame, the diffuser, and the holding member in the backlight in accordance with Preferred Embodiment 4.

FIG. 8 is a perspective view schematically showing an arrangement relationship among the plastic frame, the diffuser, and the holding member in the backlight in accordance with Preferred Embodiment 5.

FIG. 9 is a planar perspective view of the commonly used light source unit.

FIG. 10 is a schematic cross-sectional view of the light source unit taken along dashed line X-Y in FIG. 9.

### DETAILED DESCRIPTION OF THE PREFERRED EMBODIMENTS

The present invention is described in more detail below with reference to preferred embodiments illustrated in the drawings, but the present invention is not limited to only these preferred embodiments.

### Preferred Embodiment 1

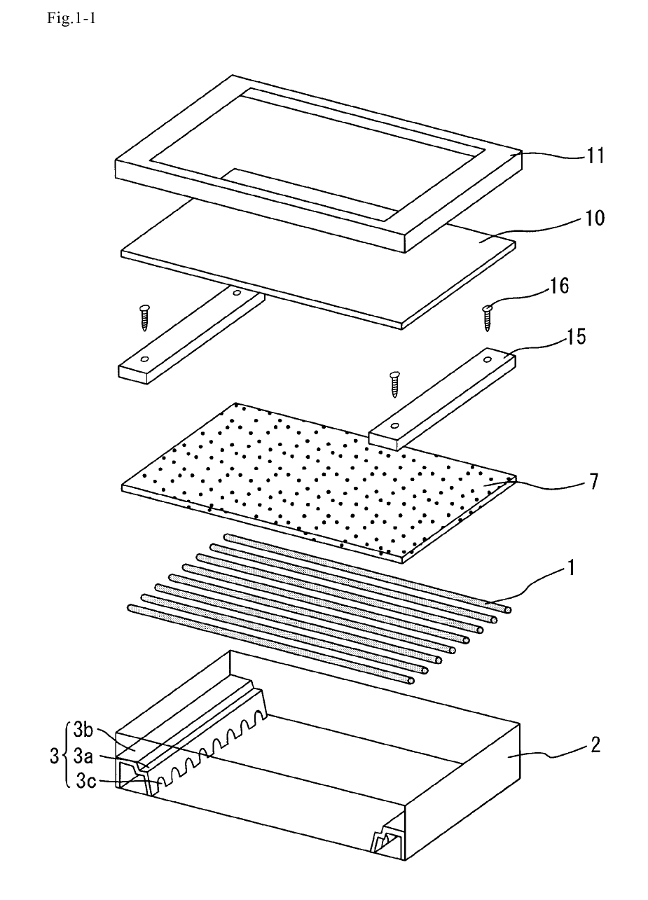

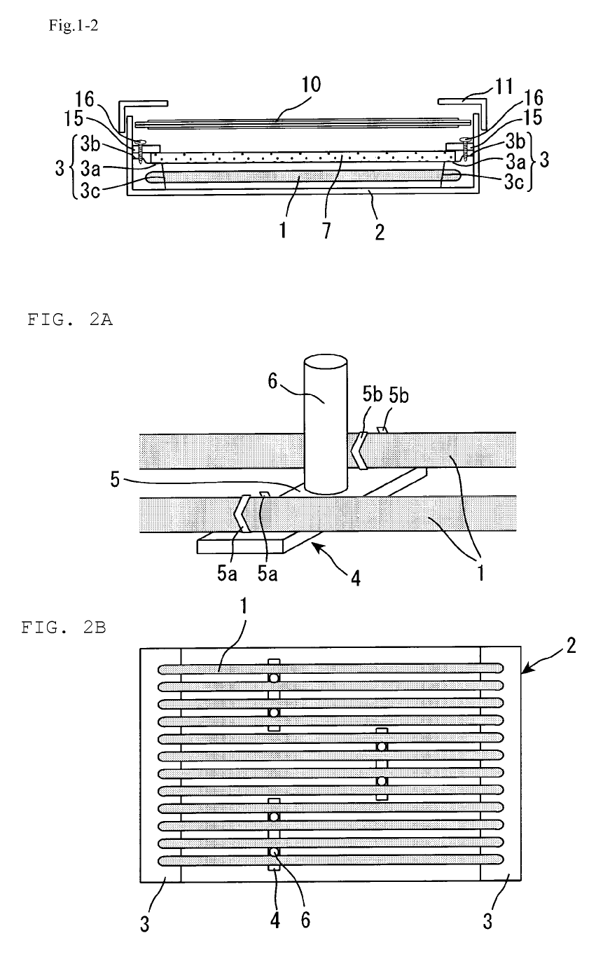

A light source unit according to Preferred Embodiment 1 is in accordance with one preferred embodiment of the light source unit of the present invention, and it can be used as a direct type backlight for liquid crystal display devices. FIG. 1-1 is a perspective exploded view schematically showing a configuration of a liquid crystal display device in accordance with Preferred Embodiment 1. FIG. 1-2 is a cross-sectional view schematically showing the configuration of the liquid crystal display device in accordance with Preferred Embodiment 1, as viewed in the direction perpendicular to the longitudinal direction of a linear light source.

As shown in FIGS. 1-1 and 1-2, the liquid crystal display device in Preferred Embodiment 1 preferably has a configuration in which a lower frame (light source chassis) 2, linear light sources 1, a plastic frame (mounting base) 3, a diffuser 7, a holding member 15, a screw 16, a liquid crystal panel 10, and an upper frame (light source chassis) 11 are stacked.

### Lower Frame and Linear Light Source

The lower frame 2 is a box casing whose top is an opening. On the short sides of the inner periphery of the lower frame 2, the plastic frame 3 supporting the diffuser 7 is arranged. The plastic frame 3 is preferably constituted by a diffuser-mounted portion 3a on which the diffuser 7 is placed, and a projection portion 3b arranged along the outer edge of the diffuser 7. The inside of the plastic frame 3 is hollow. Inside the lower frame 2, a plurality of the linear light sources (lamps) 1 are arranged parallel or substantially parallel to each other, and both ends of the light sources 1 are within the plastic frame 3 through through-holes 3c the plastic frame 3 surface has. A reflective member is placed on the bottom of the lower frame 2 to reflect light from the linear light sources 1, and thereby use efficiency of light from the linear light sources 1 can be improved. Metals such as aluminum and stainless are preferably used as a material for the lower frame 2 in view of a heat releasing property, mechanical strength, shape stability, lightweight property, and costs. A cold cathode fluorescent lamp is preferably used as the linear light sources 1.

FIGS. 2A and 2B are views schematically showing a method of holding the linear light sources 1 in the liquid crystal display device in accordance with Preferred Embodiment 1. FIG. 2A is an enlarged perspective view of a light source-holding member 4. FIG. 2B is a planar view showing arrangement of the light source-holding member 4. As shown in FIG. 2, one light source-holding member 4 preferably includes four, for example, light source-gripping portions 5 arranged at regular intervals and two supporting pins 6. A pair of the light source-gripping portions 5 defines a structure of gripping the linear light source 1 and fixes a position of the linear light source 1. The supporting pin 6 supports the diffuser 7 from below. The supporting pin 6 is arranged between the first light source-gripping portion 5a and the second light source-gripping portion 5b, and between the third light source-gripping portion and the fourth light source-gripping portion when the four light source-gripping portions 5 provided for one light source-holding member 4 are defined as the first light source-gripping portion 5a, the second light source-gripping portion 5b, the third light source-gripping portion, and the fourth light source-gripping portion.

### Mounting Base

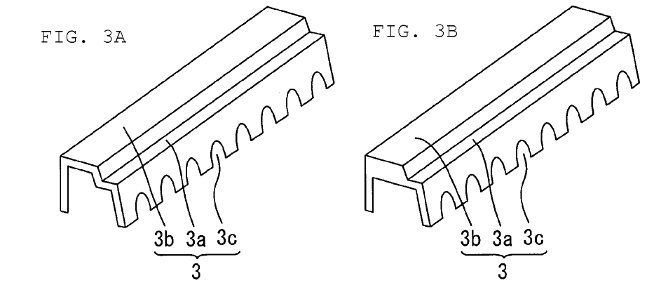

FIGS. 3A and 3B are planar views schematically showing a structure of a plastic frame in the backlight in accordance with Preferred Embodiment 1. FIG. 3A shows a plastic frame in accordance with Preferred Embodiment 1. FIG. 3B shows another plastic frame which can be used in Preferred Embodiment 1. As shown in FIG. 3A, the plastic frame 3 preferably has a two-stage structure constituted by the diffuser-mounted portion 3a and the projection portion 3b. The plastic frame 3 in Preferred Embodiment 1 has a hollow below the diffuser-mounted portion 3a so that the both ends of the light sources 1 are arranged below the diffuser-mounted portion 3a. Further, the inner surface of the light source unit in the plastic frame 3 has a plurality of through-holes 3c so that the both ends of the light sources 1 are arranged within the hollow. The plastic frame 3 in Preferred Embodiment 1 is not limited to a preferred embodiment in which the inside of the projection part 3b is also hollow as shown in FIG. 3A, as long as the plastic frame 3 has a hollow below the diffuser-mounted portion 3a. The plastic frame 3 may have a preferred embodiment in which the inside of the projection part 3b is not hollow as shown in FIG. 3B. The diffuser-mounted portion 3a has a flat surface, and the projection portion 3b is inclined toward the inside of the light source unit so as to serve as the guide to regulate the position of the diffuser. The diffuser-mounted portion 3a surface is provided with fine irregularities. In Preferred Embodiment 1, a light-shielding opalescent polycarbonate is used for the chassis (mounting-base), but the material is not especially limited. Plastics such as polypropylene also can be used for the chassis, for example.

### Diffuser

Above the lower frame 2, the diffuser 7 is arranged to cover the opening of the lower frame 2. Thus, by arranging the diffuser 7 above the light sources 1, an image of the light sources 1 can be eliminated. As a result, uniform in-plane light can be obtained. The diffuser 7 is supported by the plastic frame 3 within the lower frame 2 and also by the supporting pin 6 provided for the light source-holding member 4.

According to Preferred Embodiment 1, a diffuser (hereinafter, also referred to as a high-performance diffuser) which includes a lens structure and therefore exhibits a light-collecting function preferably is used as the diffuser 7. Specifically, the diffuser 7 has a structure in which a diffuser and a lens structure are integrated. Such a diffuser 7 has both of a light-diffusing function and a luminance-improving function. Such a diffuser 7 may further include a diffusion sheet, a polarization reflective sheet, and the like. The diffuser 7 may not have such a lens function. A preferred embodiment in which a commonly used diffuser which mainly exhibits diffusion functions is used, and an optical sheet having a light-collecting and diffusion function is additionally prepared and mounted on the diffuser may be adopted. As the optical sheet, one or more optical sheets such as a diffusion sheet, a lens sheet, a polarization reflective sheet, and the like, are appropriately used. Polyethylene terephthalate (PET), polycarbonate, and the like, are mentioned as a material for the diffusion sheet. Examples of a material for the lens sheet include UV curable resins such as an acrylic resin and materials prepared by mixing polyethylene terephthalate with UV curable resins such as an acrylic resin.

The diffuser 7 preferably is a plate member having a substantially uniform thickness. The thickness of the diffuser 7 is preferably about 0.5 mm or more and about 4 mm or less, and more preferably about 2 mm or more and about 3 mm or less, generally. If the thickness of the diffuser 7 is too large, high costs, an increase in product weight, a reduction in luminance, and yellowing of emitted light, and the like, might be caused. If the thickness of the diffuser 7 is too small, uniformity of emission light becomes difficult to secure. Further, a variation in thickness directly leads to a variation in uniformity of emission light or in luminance. Therefore, product qualities become difficult to make uniform. These problems are also generated in the case that a common diffuser or a high-function diffuser (in Preferred Embodiment 5, for example) is used.

Examples of a material for the diffuser 7 include polycarbonate (PC), methyl methacrylate-styrene copolymer (MS), polymethylmethacrylate (PMMA), cycloolefins, and glass. Among these, polycarbonate, methyl methacrylate-styrene copolymer are preferably used, for example. Each of the total light transmittance and a diffusion transmittance of the diffuser 7 is preferably about 20% to about 80% and more preferably about 40% to about 65%. If the total light transmittance and the diffusion transmittance of the diffuser 7 are too large, the uniformity of the emission light may be difficult to secure. If they are too small, the luminance of the emission light cannot be secured, which possibly results in a reduction in light emission efficiency. These problems are also generated in the case that a common diffuser or a high-function diffuser is used.

### Holding Member

The holding member 15 is arranged on the short sides of a rectangular optical sheet 8. This holding member 15 is fixed to the plastic frame 3 preferably with screws 16 each fixed to each end of the holding member 15, for example. A metal screw can be used as the screw 16, for example. The screw 16 is fixed to penetrate the holding member 15 and the plastic frame 3 from the upper surface side of the holding member 15 to the plastic frame 3. Accordingly, the screw 16 does not need to penetrate the diffuser 7. Therefore, the diffuser 7 is not broken. In Preferred Embodiment 1, opalescent polycarbonate is used as a material for the holding member 15, but the material for the holding member 15 is not especially limited as long as it can prevent the diffuser 7 from sagging at the corners of the diffuser 7. The holding member 15 preferably has light-shielding property and more preferably has reflectivity. Accordingly, plastics such as an acrylic resin and polypropylene, and metals such as aluminum and iron are also preferable as the material for the holding member 15. The holding member made of such a material has inflexibility and therefore does not warp, unlike the diffuser. Therefore, such a holding member has a high holding effect.

The length in the in-plane direction of the holding member 15 can be appropriately determined depending on the size of the diffuser 7. It is optimal to set the length in the in-plane direction of the holding member 15 to be as long as possible toward the diffuser 7 unless the holding member overlaps with an active display region. The following Table 1 shows a length in the in-plane direction of the holding member 15 and a thickness of the holding member in the case that the liquid crystal display device in accordance with Preferred Embodiment 1 includes a diffuser which is made of polycarbonate and has a thickness of about 2 mm or about 3 mm, for example, as the diffuser 7. The screen size in Table 1 is expressed as a length (inch) of a diagonal line of a display screen in the liquid crystal display device. The length is almost the same as a length of a diagonal line of the diffuser 7.

TABLE 1

| | | | Length in in- | |
|---|---|---|---|---|
| | | Thickness of | plane direction | Thickness of |
| | | diffuser | of holding | holding member |
| Screen size | Material | [mm] | member [mm] | [mm] |
| 65-inch | PC | 3 | 10 | 6 |
| 45-inch | PC | 2 | 10 | 6 |
| 37-inch | MS | 2 | 10 | 6 |
| 32-inch | MS | 2 | 10 | 6 |

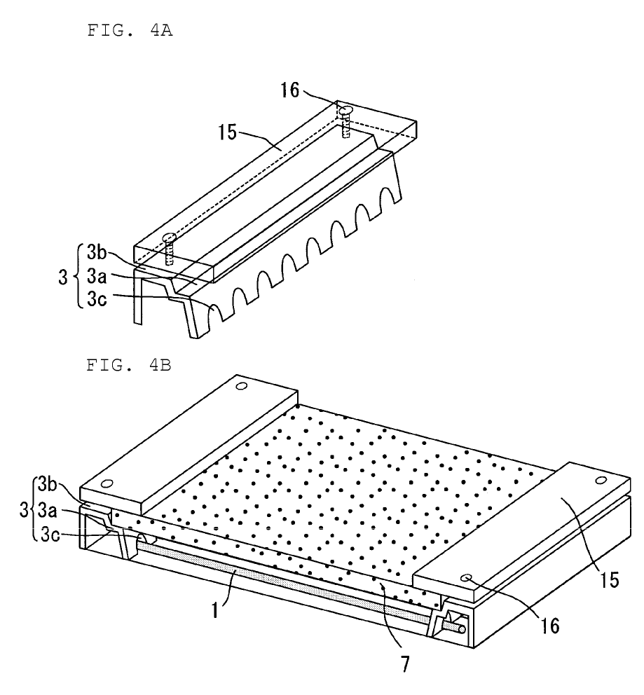

FIGS. 4A and 4B are planar views schematically showing an arrangement relationship among the plastic frame 3, the diffuser 7, the holding member 15, and the screw 16 in the backlight in accordance with Preferred Embodiment 1. FIG. 4A is an enlarged perspective view showing the plastic frame 3 and the holding member 15. FIG. 4B is an overall view showing the diffuser 7 and the light source 1.

As shown in FIG. 4A, the holding member 15 preferably is a rectangular plate, and it is fixed to the plastic frame 3 with the crews 16 each of which is fixed to each end of the holding member 15. The holding member 15 may not be necessarily in contact with the plastic frame 3. The distance between the holding member 15 and the plastic frame 3 is determined by the thickness of the diffuser 7. According to Preferred Embodiment 1, the diffuser 7 is close to the diffuser-mounted portion 3a. The upper surface of the diffuser 7 is arranged to be above the level of the projection portion 3b of the plastic frame 3. Therefore, a certain space exists between the holding member 15 and the plastic frame 3, but the holding member 15 and the plastic frame 3 are fixed with the screws, for example. Therefore, the diffuser 7 is interposed between the holding member 15 and the plastic frame 3, and as a result, the sagging of the diffuser can be sufficiently prevented.

As shown in the overall view in FIG. 4B, the plastic frame 3 covers the both ends of the light sources 1 which transversely penetrate the through-holes 3c, and on the diffuser-mounted portion 3a, the diffuser 7 is mounted. The projection portion 3b is arranged on the short sides of the diffuser 7 and also serves as a guide which regulates a position of the diffuser 7. The holding member 15 is arranged to cover an edge of the upper surface including the corners of the diffuser 7, and coupled with the plastic frame 3, with the screws 16, which are fixed to both ends of the holding member 15, one to each end. According to Preferred Embodiment 1, the holding member 15 preferably is arranged only on the short sides of the diffuser 7. However, in order to more sufficiently prevent deterioration of display qualities, it is preferable to arrange the holding member 15 also on the long sides of the diffuser 7. It is preferable that the holding member 15 covers an edge of the upper surface of the optical sheet if not the high-performance diffuser but a common diffuser is used as the diffuser, and then, the optical sheet is arranged on the diffuser. In such a case, the holding member 15 also serves as a seat-holding member for stabilizing a position of the optical sheet.

### Liquid Crystal Panel and Upper Frame

The liquid crystal panel 10 is arranged above the holding member 15. The liquid crystal panel 10 has a configuration in which a liquid crystal layer is interposed between glass substrates, and a retardation film, a polarizer, and the like, are each attached to glass substrate surfaces on the side opposite to the liquid crystal layer side. In addition, the upper frame 11 is fitted with the lower frame 2 from the display surface side of the liquid crystal panel 10. Examples of a preferable material for the upper frame 11 include a metal such as aluminum and stainless, similarly to the lower frame 2.

In such a manner, the liquid crystal display device in Preferred Embodiment 1 is completed.

The liquid crystal display device in Preferred Embodiment 1 can provide display with display qualities whose deterioration is sufficiently prevented because the light leakage generated at the corners of the diffuser is prevented.

### Preferred Embodiment 2

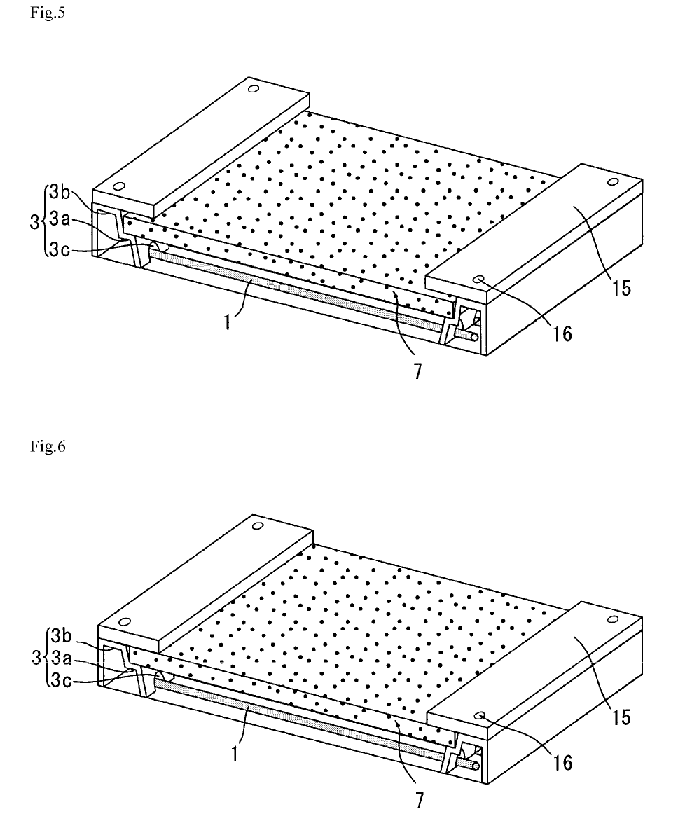

A light source unit in Preferred Embodiment 2 is in accordance with another preferred embodiment of the light source unit of the present invention, and it can be used as a direct type backlight for liquid crystal display devices. FIG. 5 is a perspective view schematically showing an arrangement relationship among a plastic frame (mounting base), a diffuser, and a holding member in the backlight in accordance with Preferred Embodiment 2. The backlight in Preferred Embodiment 2 is the same as in Preferred Embodiment 1, except that the projection portion 3b of the plastic frame 3 is arranged to be above the level of the upper surface of the diffuser 7. That is, the backlight in Preferred Embodiment 2, covers the both ends of the light sources 1 which transversely penetrate the through-holes 3c, and the diffuser 7is mounted on the diffuser-mounted portion 3a. The projection portion 3b is arranged on the short sides of the diffuser 7 and also serves as a guide which regulates a position of the diffuser 7. The holding member 15 is arranged to cover the corners including an edge of the upper surface of the diffuser 7, and coupled with the plastic frame 3, with the screws 16 each fixed to each end of the holding member 15.

According to Preferred Embodiment 2, a certain space exists between the diffuser 7 and the holding member 15 arranged above the diffuser 7. Also in such a structure, the plastic frame 3 is coupled with the holding member 15 with the screws 16, and thereby they are fixed to each other and the holding member 15 covers the upper surface of the diffuser 7. Therefore, even if the diffuser sags, the holding member 15 acts as a stopper to prevent the diffuser 7 from sagging beyond a certain degree.

### Preferred Embodiment 3

A light source unit in Preferred Embodiment 3 is in accordance with another preferred embodiment of the light source unit of the present invention, and it can be used as a direct type backlight for liquid crystal display devices. FIG. 6 is a perspective view schematically showing an arrangement relationship among the plastic frame (mounting base), the diffuser, and the holding member in the backlight in accordance with Preferred Embodiment 3. The backlight in Preferred Embodiment 3 is the same as in Preferred Embodiment 1, except that the projection portion 3b of the plastic frame 3 is arranged to be at the same level of the upper surface of the diffuser 7. That is, the backlight in Preferred Embodiment 3, covers the both ends of the light sources 1 which transversely penetrate the through-holes 3c, and the diffuser 7 is mounted on the diffuser-mounted portion 3a. The projection portion 3b is arranged on the short sides of the diffuser 7 and also serves as a guide which regulates a position of the diffuser 7. The holding member 15 is arranged to cover the corners including an edge of the upper surface of the diffuser 7, and coupled with the plastic frame 3, with the screws 16 each fixed to each end of the holding member 15.

According to Preferred Embodiment 3, no space exists between the diffuser 7 and the holding member 15 arranged above the diffuser 7. The plastic frame 3 and the holding member 15 are coupled with each other with the screws 16, and the diffuser 7, the plastic frame 3, and the holding member 15 are fixed together. Therefore, the diffuser 7 can be effectively prevented from sagging.

### Preferred Embodiment 4

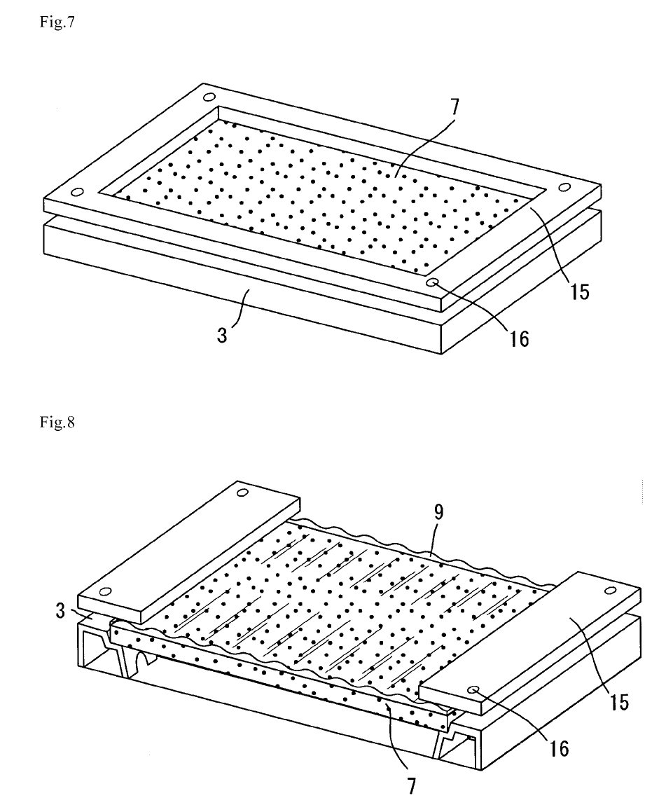

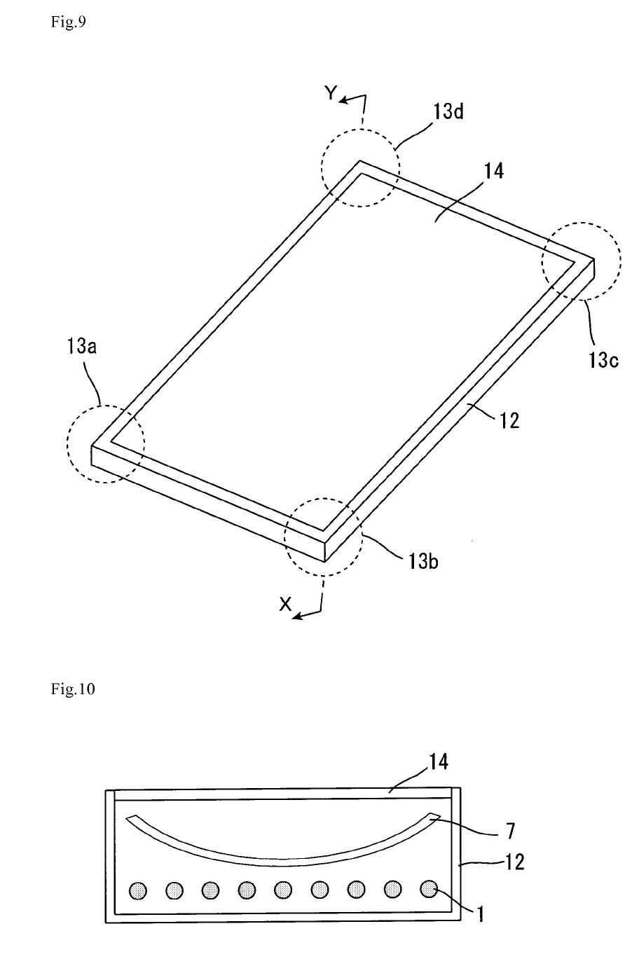

A light source unit in Preferred Embodiment 4 is in accordance with another preferred embodiment of the light source unit of the present invention, and it can be used as a direct type backlight for liquid crystal display devices. FIG. 7 is a perspective view schematically showing an arrangement relationship among the plastic frame (mounting base), the diffuser, and the holding member in the backlight in accordance with Embodiment 4. The backlight in Preferred Embodiment 4 is the same as in Preferred Embodiment 1, except that the holding member 15 and the plastic frame 3 are circularly arranged along the outer edge of the diffuser 7. That is, according to Preferred Embodiment 4, the plastic frame 3 is arranged below the outer edge of the diffuser 7, and the holding member 15 is arranged above the outer edge of the diffuser 7, and further, the holding member 15 and the plastic frame 3 are coupled with and fixed to each other with the screws 16, and the diffuser 7 is interposed between the plastic frame 3 and the holding member 15.

According to this arrangement of the holding member 15 and the plastic frame 3, the “sagging” of the diffuser 7 can be prevented not only at the corners but also in the entire outer edge of the diffuser 7. Therefore, the light leakage can be more surely prevented. As a result, the deterioration of display qualities can be effectively prevented.

### Preferred Embodiment 5

A light source unit in Preferred Embodiment 5 is in accordance with another preferred embodiment of the light source unit of the present invention, and it can be used as a direct type backlight for liquid crystal display devices. FIG. 8 is a perspective view schematically showing an arrangement relationship among the plastic frame (mounting base), the diffuser, and the holding member in the backlight in accordance with Preferred Embodiment 5. The configuration of the backlight in Preferred Embodiment 5 is the same as in Preferred Embodiment 1, except that a lenticular lens 9 is arranged on a surface of the diffuser 7. As shown in FIG. 8, the diffuser 7 is integrated with the lenticular lens 9 by arranging the lenticular lens 9 on a surface of the diffuser 7 mounted on the plastic frame 3. The holding member 15 is arranged to cover the corners including an edge of the upper surface of the diffuser 7, and coupled with the plastic frame 3, with the screws 16 each fixed to each end of the holding member 15. According to this preferred embodiment, there is no need to arrange a lens sheet, and it does not occur that a lens sheet unevenly sags. As a result, the diffuser functions and the lens functions can be consolidated and the effect of improving the luminance can be obtained.

### Preferred Embodiment 6

The liquid crystal display devices in Preferred Embodiments 1 to 5 can provide display with display qualities whose deterioration is effectively prevented. Therefore, if these liquid crystal display devices each constitute a television receiver, for example, a television which displays images with high quality can be provided.

The present application claims priority under the Paris Convention and the domestic law in the country to be entered into national phase on Patent Application No. 2006-329852 filed in Japan on Dec. 6, 2006, the entire contents of which are hereby incorporated by reference.

The terms “or more” and “or less” in the present description mean that the value described (boundary value) is included.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-12. (canceled)

13. A light source unit comprising:
a light source;
a diffuser; and
a light source chassis; wherein
the light source and the diffuser are arranged in this order from a bottom within the light source chassis;
a mounting base is arranged below a corner of the diffuser;
a holding member is arranged above the corner of the diffuser;
the mounting base and the holding member are coupled with each other; and
the diffuser is interposed between the mounting base and the holding member.

14. The light source unit according to claim 13, wherein the mounting base and the holding member are circularly arranged along an outer edge of the diffuser.

15. The light source unit according to claim 13, wherein the mounting base is made of polycarbonate or polypropylene.

16. The light source unit according to claim 13, wherein the holding member has a light-shielding property.

17. The light source unit according to claim 13, wherein the holding member has reflectivity.

18. The light source unit according to claim 13, wherein the holding member is made of polycarbonate or polypropylene.

19. The light source unit according to claim 13, wherein the holding member is made of aluminum or iron.

20. The light source unit according to claim 13, wherein the mounting base and the holding member are coupled with each other via a screw.

21. The light source unit according to claim 13, wherein the diffuser is made of polycarbonate or a methyl methacrylate-styrene copolymer.

22. The light source unit according to claim 13, wherein the diffuser has a lens structure.

23. A display device comprising the light source unit according to claim 13.

24. A television receiver comprising the display device according to claim 23.
